(19) United States
(12) Patent Application Publication
(10) Pub. No.: US 2007/0106521 A1
(43) Pub. Date: May 10, 2007

(54) System and method to process media with preset credit

(75) Inventors: Chi Fai Ho, Palo Alto, CA (US); Shin Cheung Simon Chiu, Palo Alto, CA (US)

Correspondence Address: Fernandez & Associates, LLP, PO Box D, Menlo Park, CA, 94025-6204, US

(73) Assignee: TP Lab, Palo Alto, CA (US)

(21) Appl. No.: 11/267,453

(22) Filed: Nov. 4, 2005

(51) Int. Cl. G06Q 99/00

(52) U.S. Cl. 705/1

(57) ABSTRACT

A preset credit media includes: a document part, and availability information and credit for the document part. The document part is all or less than all of an audio file, a visual file, a text file, or a data file. The availability information includes a monetary cost or time availability for the document part. The credit includes a monetary credit, a time credit, or a transaction credit for the document part. To play the document part, it is determined if enough credit exists for the document part to be played, based on the availability information and the credit. If so, the document part is retrieved from the preset credit media and played. The credit is modified accordingly. To change a preset credit media, a change request is received and verified. Any combination of the document part, the availability information, and the credit may be modified according to the change request.

### BACKGROUND

1. Field

This invention relates generally to media, and more specifically to a system and method to process media with preset credit.

2. Related Art

Modern technologies enable digital media. Not only are existing documents converted into digital format, creation of new documents is also adapting to digital formats. For examples, in the music industry, most songs, new and old, are now available in digital formats such as MP3 or WMA. The movie industry distributes new titles using digital format and DVD. The publishing industry starts to distribute books in electronic format such as PDF or Microsoft Word™. The financial industry has been adopting electronic formats for security document filing for several years. Many other fields and industries have adopted, or are in process of adopting, digital formats for document creation and distribution.

Although document formats have adapted to new technologies, the ability to view or play a document has not changed fundamentally. For example, a consumer purchases a song on a disc. She believes that since she pays for the song, she can play the song for a very long time. She is not aware that the song-playing software that plays the song may become obsolete and will not be supported in the next release. She will not be able to purchase compatible software to play the song. That means, even though she still owns the disc containing the song, she will not be able to play the song. In another scenario, the software requires a computing device that is no longer available three years later. She faces the same problem as in the other scenario. In other words, the digital song she purchases has a very limited meaningful life.

For another example, a customer rented a movie on a DVD. The rental is for 2 days, but he forgets to return the DVD on time. When he returns the DVD after a month, the movie rental company charges him one dollar for each day late. Although he did not view the movie after the 2 day rental period, he is still required to pay the late return penalty.

In another scenario, a song library distributor wants to sell selected albums of love songs of the 50's, 60's, 70's, 80's and 90's. Since the distributor does not know which era will attract the most customers, it wants to minimize the production cost by producing one DVD containing all albums. Customers can select the decade of choice, and activates only the selected albums but not the others. In this scenario, the cost of the document is minimal. If the distributor produces individual DVD for each era, the distributor will end up with a high unsold inventory for some eras while popular selling eras will suffer shortage.

The above illustrates a need to introduce a new media format that connects a document to a specification of limited availability of the document in the media.

### SUMMARY

A preset credit media includes: a document part, and availability information and credit for the document part. The document part is all or less than all of an audio file, a visual file, a text file, or a data file. The availability information includes a monetary cost or time availability for the document part. The credit includes a monetary credit, a time credit, or a transaction credit for the document part. To play the document part, it is determined if enough credit exists for the document part to be played, based on the availability information and the credit. If so, the document part is retrieved from the preset credit media and played. The credit is modified accordingly. To change a preset credit media, a change request is received and verified. Any combination of the document part, the availability information, and the credit may be modified according to the change request.

### BRIEF DESCRIPTION OF DRAWINGS

FIG. 1 illustrates a structure for a Preset Credit Media.

FIG. 2 illustrates a process to play a document part from a Preset Credit Media.

FIG. 3 illustrates a process to change a Preset Credit Media.

FIG. 4 illustrates a process of setting a Preset Credit Media.

### DETAILED DESCRIPTION

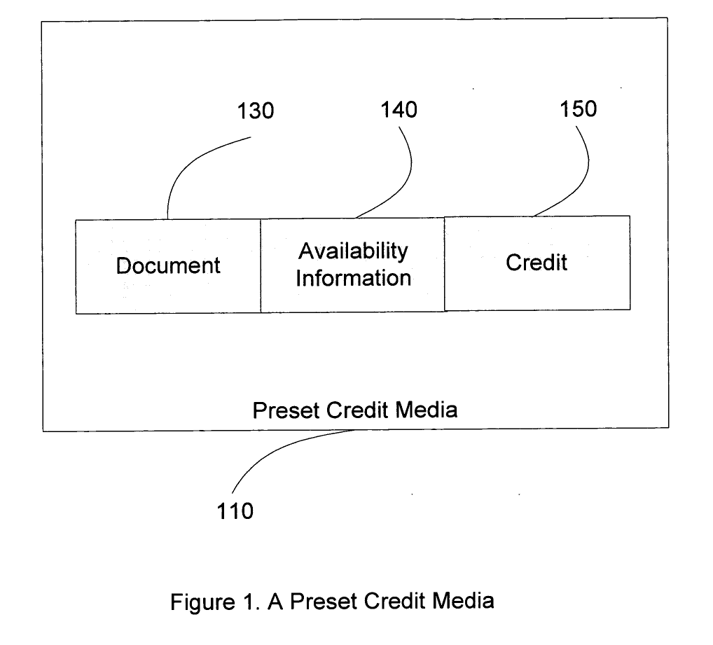

FIG. 1 illustrates a structure for a Preset Credit Media. A Preset Credit Media 110 includes a document 130, availability information 140 and credit 150. In one embodiment, a document 130 is an audio file, such as a song, a speech, a recorded sound, or an audio clip. In one embodiment, a document 130 is a video file, such as a movie, an animation clip, a video clip, a television program recording, or a video recording. In one embodiment, a document 130 is an article, such as a book, a piece of news, a written paper, a contract document, a spreadsheet, or presentation slides. In one embodiment, a document 130 is a picture, such as a photo, a graphical image, a graph, a table.

In one embodiment, a document 130 is a file folder, an album, a directory, or a volume. For example, a document 130 is a music album containing a plurality of songs; document 130 is a book volume containing a book series; a document 130 is a file folder of computer presentation files; a document 130 is a collection of binary data files; a document 130 is a collection of movies; a document 130 is a collection of photo albums.

A document part is a part of document 130. A document part can be the entire document 130. For example, document 130 is a book and a document part is a chapter; document 130 is a song album and a document part is a song; document 130 is a movie and a document part is a movie clip; document 130 is a computer presentation file and a document part is a slide. In one embodiment, document 130 is an album and a document part is the album.

In one embodiment, availability information 140 includes a monetary cost about the document 130. For example, an article titled “ABC” is available for 10 dollars; a song titled “XYZ” is available for 10 cents per play; a movie directory titled “Star Wars Episodes” is available for $1 per movie per play; a photo titled “Yellow Stone Glacier” is available for no charge; a music album is available for 50 cents per song per play; the document 130 is available for $100.

In one embodiment, availability information 140 includes time availability for the document 130. For example, a song album titled “ABCD” is available until Jul. 21, 2007; a book titled “EFGH” is available between 8 am and 5 pm during weekends; a photo album titled “Yellow Stone in Autumn” is available for 48 hours after it is first accessed; a movie titled “Fantasia” is always available; a movie folder is available during week days; the document 130 is available for 3 months.

In one embodiment, credit 150 includes monetary credit about the document 130. For example, an article titled “ABC” has 50 dollar credit; a song titled “XYZ” has 1 dollar credit; a movie directory titled “Star Wars Episodes” has $5 credit; a book title “ABCDE” has zero dollar credit; a music album titled “Winder Classics” has $10 credit; the document 130 has $200 credit.

In one embodiment, credit 150 includes time credit about the document 130. For example, a song album titled “ABCD” has 4 hours of credit; a book titled “EFGH” has 100 hours of credit; a photo album titled “Yellow Stone in autumn” has 10 days of credit; a movie titled “Fantasia” has 6 months of credit; the document 130 has one year of credit.

In one embodiment, credit 150 includes transaction credit about the document 130. For example, a song title “Welcome to Olympics 2020” has credit for unlimited number of plays; a song album titled “RAP 2015” has credit for 10 plays; a movie titled “Trojan” has credit for 1 play; the document 130 has credit for 100 plays.

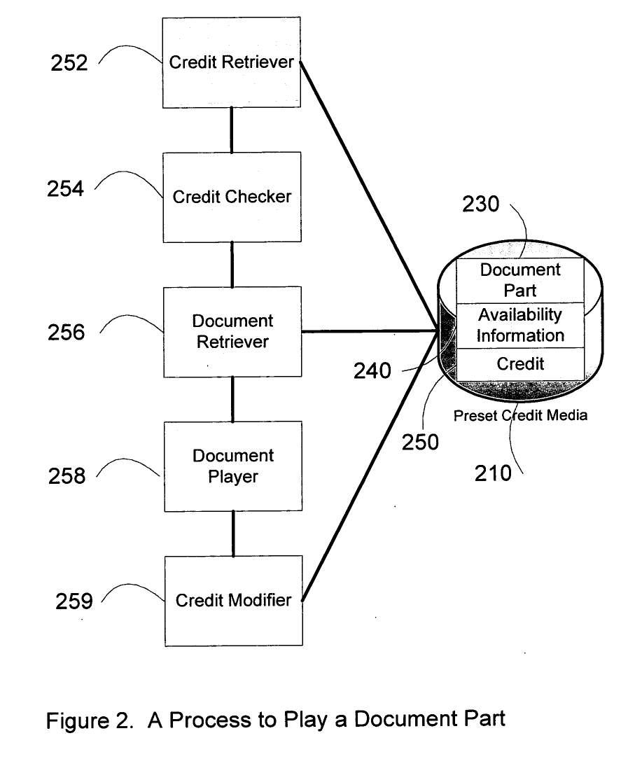

FIG. 2 illustrates a process to play a document part from a Preset Credit Media. The process of playing includes a plurality of steps.

Credit retriever 252 retrieves, from Preset Credit Media 210, availability information 240 and credit 250.

Credit checker 254 checks if there is sufficient credit to play document part 230. In one embodiment, the availability information 240 is a monetary cost, and the credit 250 is a monetary credit. Credit checker 254 calculates the cost to play document part 230 based on the availability information 240. In one embodiment, the document part 230 is a song of an album, and the album is available for a dollar per song. The cost to play document part 230 is one dollar. In another embodiment, the document part 230 is a movie titled “ABCD”, and the movie is available for $10. The cost to play document part 230 is $10. Credit checker 254 determines if credit 250 is larger than or the same as the cost to play document part 230, there is sufficient credit to play document part 230.

In one embodiment, availability information 240 is time availability and the current time is within the time availability, there is sufficient credit to play document part 230.

In one embodiment, credit 250 is a time credit and the value is higher than 0, there is sufficient credit to play document part 230. In one embodiment, credit 250 has a value higher than or the same as the time necessary to play the document part 230, there is sufficient credit to play document part 230.

In one embodiment, credit 250 is a transaction credit and the value is higher than 0, there is sufficient credit to play document part 230.

In one embodiment, Preset Credit Media 210 has a plurality of availability information and a plurality of credit, determining if there is sufficient credit to play document part 230 requires examining a combination of availability information and credit.

Document retriever 256 retrieves document part 230 from Preset Credit Media 210. For example, document retriever 256 retrieves a song in an album; a movie in a movie album; an article in a directory; a chapter in a book.

If there is sufficient credit to play document part 230, document player 258 plays document part 230. For example, document player 258 plays a song in an album; a movie in a movie album. For example, document player 258 plays a chapter in a book by displaying the chapter. For example, document player 258 presents an article in a directory.

Credit modifier 259 modifies the credit 250 of Preset Credit Media 210.

In one embodiment, credit 250 is a monetary credit. Credit modifier 259 modifies credit 250 based on an amount specified in the availability information 240. In one embodiment, credit 250 is reduced based on document part 230 played by document player 258. For example, document part 230 includes two songs and availability information is 25 cents per song per play. Credit 250 is reduced by 50 cents. In another embodiment, the document part 230 includes a promotional song and availability information is 25 cents per play. Credit 250 is increased by 25 cents.

In one embodiment, the credit 250 is a time credit. Credit modifier 259 modifies credit 250 by reducing credit 250 based on the duration of document part 230. In one embodiment, credit 250 is reduced by the duration of the play time of document player 258 while playing document part 230.

In one embodiment, the credit 250 is a transaction credit. Credit modifier 259 modifies credit 250 by reducing credit 250 based on document part 230. For example, document part 230 includes two songs. Credit 250 is reduced by 2.

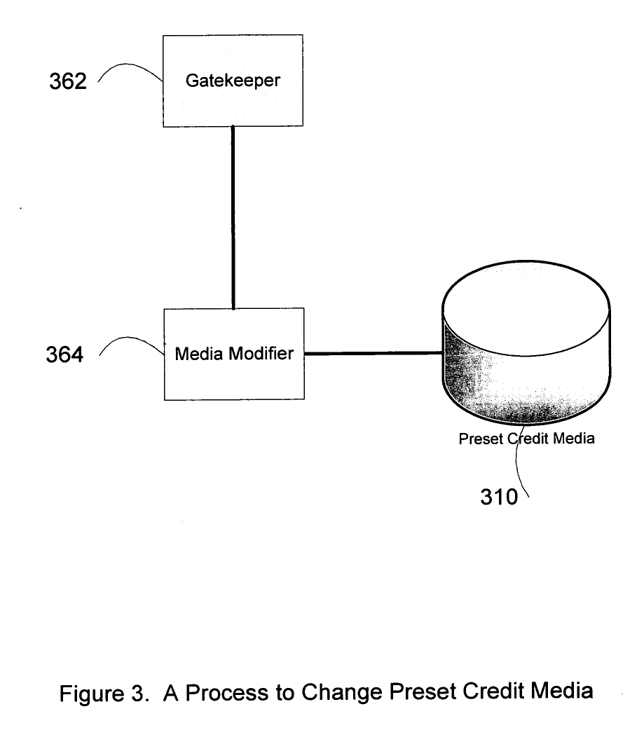

FIG. 3 illustrates a process to change a Preset Credit Media. A process to change Preset Credit Media 310 includes a plurality of steps applied to a change request.

In one embodiment, a change request includes a key. Gatekeeper 362 checks if the key is valid. In one embodiment, Gatekeeper 362 includes a memory, and matches the key with a plurality of pre-stored keys in the memory. If there is a match, the key is valid. In one embodiment, Gatekeeper 362 sends a query to a network to check if the key is valid.

In one embodiment, a change request includes data to be stored in Preset Credit Media 310. In one embodiment, the data includes a document part. Media modifier 364 stores the document part into Preset Credit Media 310. In one embodiment, the data includes availability information. Media modifier 364 updates the availability information of Preset Credit Media 310 with the availability information in the data. In one embodiment, the data includes credit. Media modifier 364 updates the credit of Preset Credit Media 310 with the credit in the data.

In one embodiment, the change request includes a request to remove a document part. Media modifier 364 deletes the document part from Preset Credit Media 310.

In one embodiment, the change request includes a change type specifying if the change request is for a document, for availability information, or for credit. In one embodiment, the change type specifies if the change request is for monetary cost, or for time availability. In one embodiment, the change type specifies if the change request is for monetary credit, for time credit, or for transaction credit. Gatekeeper 362 checks if the key is valid with respect to the change type. In one embodiment, different change types associate to different keys.

In one embodiment, media modifier 364 processes change requests only for certain change type. For example, media modifier 364 processes change requests for document. For example media modifier 364 does not process change requests for credit.

Preset Credit Media can be used in many applications. For example, the change request can be initiated by a merchant, a media rights owner, or a consumer. For another example, the network is a network of a copyright owner of the document. Different variations of steps in FIG. 3 are described in the following to illustrate different applications.

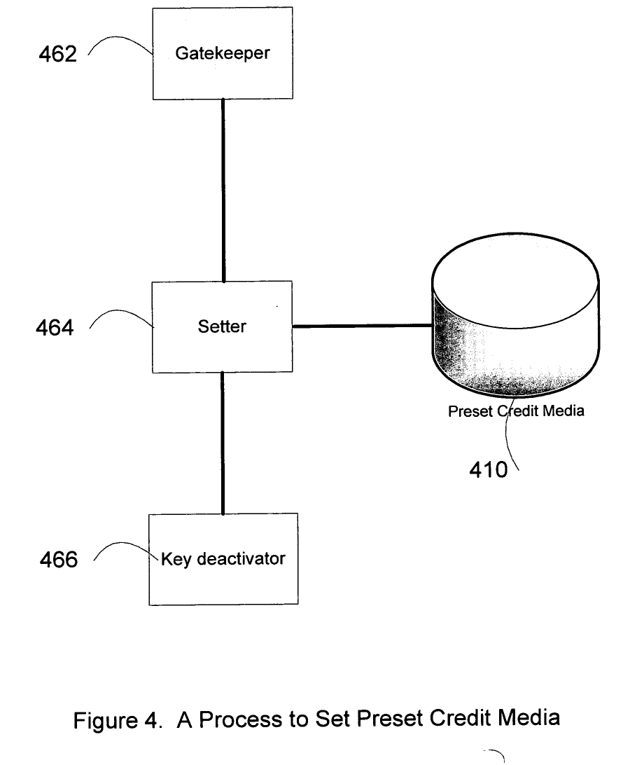

FIG. 4 illustrates a process of setting a Preset Credit Media with time credit. The process includes a plurality of steps applied to a setting request.

In one embodiment, the setting request includes a key. Gatekeeper 462 checks if the key is valid by matching the key with a plurality of pre-stored keys in memory. In another embodiment, Gatekeeper 462 checks if the key is valid by sending a query to a network.

Setter 464 modifies Preset Credit Media 410 based on a setting. In one embodiment the setting is based on the setting request. In one embodiment, the setting is based on the key in the setting request. In one embodiment, Gatekeeper 462 obtains the setting using the key, and sends the setting to setter 464. In another embodiment, setter 464 includes a memory, for example storage or program memory. The setting is stored in the memory. In one embodiment the setting includes a time credit.

In one embodiment, setter 464 modifies by overwriting Preset Credit Media 410 with the setting. In another embodiment, setter 464 modifies by adjusting Preset Credit Media 410 with the setting, for example increasing time credit for Preset Credit Media 410 by an amount specified in the setting.

In one embodiment, the plurality of steps includes the step of key deactivator 466. Key deactivator 466 deactivates the key. In one embodiment, key deactivator 466 deactivates or removes a plurality of pre-stored keys from memory. In another embodiment, key deactivator 466 informs a network to deactivate the key.

In an application where a merchant can set a price on Preset Credit Media, the application uses the steps illustrated in FIG. 4 by replacing time credit in the step of setting Preset Credit Media with monetary cost.

In an application where a merchant can set a credit on document, the application uses the steps illustrated in FIG. 4 by replacing time credit in the step of setting Preset Credit Media with a credit, a combination of time credit, monetary credit and transaction credit.

In an application where a customer can select a document part in a Preset Credit Media, the application uses the steps illustrated in FIG. 4 by replacing time credit in the step of setting Preset Credit Media with time availability. In one embodiment, the step of setting Preset Credit Media includes further setting a credit of Preset Credit Media.

Foregoing described embodiments of the invention are provided as illustrations and descriptions. They are not intended to limit the invention to precise form described. In particular, it is contemplated that functional implementation of invention described herein may be implemented equivalently in hardware, software, firmware, and/or other available functional components or building blocks, and that networks may be wired, wireless, or a combination of wired and wireless. Other variations and embodiments are possible in light of above teachings, and it is thus intended that the scope of invention not be limited by this Detailed Description, but rather by Claims following.

We claim:

1. A preset credit media, comprising:
a document part;
availability information for the document part; and
credit for the document part.

2. The media of claim 1, wherein the document part comprises all or less than all of an audio file, a visual file, a text file, or a data file.

3. The media of claim 1, wherein the availability information comprises:
a monetary cost for the document part; or
a time availability for the document part.

4. The media of claim 1, wherein the credit comprises:
a monetary credit of the document part;
a time credit for the document part; or
a transaction credit for the document part.

5. A method for playing a document part from a preset credit media, comprising:
(a) retrieving availability information and credit for the document part from the preset credit media;
(b) determining if the document part is allowed to play, based on the availability information and the credit; and
(c) retrieving the document part from the preset credit media, if the document part is allowed to play.

6. The method of claim 5, wherein the determining step (b) comprises:
(b1) calculating a credit required to play the document part, based on the availability information; and
(b2) comparing the credit required with the credit retrieved from the preset credit media to determine if sufficient credit exists to play the document part.

7. The method of claim 5, wherein the availability information comprises:
a monetary cost for the document part; or
a time availability for the document part.

8. The method of claim 5, wherein the credit comprises:
a monetary credit of the document part;
a time credit for the document part; or
a transaction credit for the document part.

9. The method of claim 5, further comprising:
(d) playing the retrieved document part.

10. The method of claim 9, further comprising:
(e) modifying the credit of the preset credit media.

11. The method of claim 10, wherein the modifying (e) comprises:
(e1) modifying a monetary credit, a time credit, or a transaction credit.

12. A method for changing a preset credit media, comprising:
(a) receiving a change request for the preset credit media, wherein the preset credit media comprises:
a document part;
availability information for the document part; and
credit for the document part;
(b) verifying a validity of the change request; and
(c) updating the preset credit media, if the change request is valid.

13. The method of claim 12, wherein the document part comprises all or less than all of an audio file, a visual file, a text file, or a data file.

14. The method of claim 12, wherein the availability information comprises:
a monetary cost for the document part; or
a time availability for the document part.

15. The method of claim 12, wherein the credit comprises:
a monetary credit of the document part;
a time credit for the document part; or
a transaction credit for the document part.

16. The method of claim 12, wherein the change request comprises a key, wherein the verifying step (b) comprises:
(b1) comparing the key with a plurality of stored keys, wherein the key is valid if the key matches one of the plurality of stored keys.

17. The method of claim 12, wherein the change request comprises a key, wherein the verifying step (b) comprises:
(b1) sending a query to a network, wherein the network determines if the key is valid.

18. The method of claim 12, wherein the change request comprises data to be stored on the preset credit media.

19. The method of claim 18, wherein the data comprises:
the document part;
the availability information; or
the credit.

20. The method of claim 12, wherein the change request comprises a request to remove the document part from the preset credit media.

21. The method of claim 12, wherein the change request comprises a change type, wherein the change type specifies if the change request is for the document part, the availability information, or the credit.

22. The method of claim 21, wherein the change request further comprises a key, wherein the key is verified if it is valid for the change type.

23. The method of claim 22, wherein different change types are associated with different keys.

24. The method of claim 12, wherein the updating step (c) comprises:
(c1) overwriting the preset credit media according to the change request.

25. The method of claim 12, wherein the updating step (c) comprises:
(c1) adjusting the preset credit media according to the change request.

26. The method of claim 12, wherein the change request comprises a key, wherein the method further comprises:
(d) deactivating the key.

27. A system, comprising:
a credit retriever for retrieving availability information and credit for a document part from a preset credit media, wherein the preset credit media comprises the document part, availability information for the document part, and credit for the document part;
a credit checker for determining if the document part is allowed to play based on the availability information and the credit; and
a document retriever for retrieving the document part from the preset credit media, if the document part is allowed to play.

28. The system of claim 27, wherein the document part comprises all or less than all of an audio file, a visual file, a text file, or a data file.

29. The system of claim 27, wherein the availability information comprises:
a monetary cost for the document part; or
a time availability for the document part.

30. The system of claim 27, wherein the credit comprises:
a monetary credit of the document part;
a time credit for the document part; or
a transaction credit for the document part.

31. The system of claim 27, further comprising:
a document player for playing the retrieved document part.

32. The system of claim 31, further comprising:
a credit modifier for modifying the credit of the preset credit media.

33. A system, comprising:
a media modifier for receiving a change request for a preset credit media, wherein the preset credit media comprises a document part, availability information for the document part, and credit for the document part; and
a gatekeeper for verifying a validity of the change request,
wherein the media modifier updates the preset credit media according to the change request, if the change request is valid.

34. The system of claim 33, wherein the document part comprises all or less than all of an audio file, a visual file, a text file, or a data file.

35. The system of claim 33, wherein the availability information comprises:
a monetary cost for the document part; or
a time availability for the document part.

36. The system of claim 33, wherein the credit comprises:
a monetary credit of the document part;
a time credit for the document part; or
a transaction credit for the document part.
